(19) United States
(12) Patent Application Publication
(10) Pub. No.: US 2019/0356756 A1
(43) Pub. Date: Nov. 21, 2019

(54) METHOD AND SYSTEM FOR DOCKETING

(71) Applicants: Frank C. Nicholas, Glenview, IL (US); Ian B. Carswell, Chicago, IL (US)

(72) Inventors: Frank C. Nicholas, Glenview, IL (US); Ian B. Carswell, Chicago, IL (US)

(21) Appl. No.: 16/526,396

(22) Filed: Jul. 30, 2019

Related U.S. Application Data
(63) Continuation of application No. 14/949,792, filed on Nov. 23, 2015, now abandoned.
Application No. 14/949,792 is a division of application No. 11/352,839, filed on Feb. 13, 2006, now abandoned.
Application No. 14/949,792 is a continuation of application No. 11/573,178, filed on Feb. 2, 2007, now abandoned.
Application No. 14/949,792 is a continuation of application No. 11/134,116, filed on May 20, 2005.
(60) Provisional application No. 60/652,283, filed on Feb. 11, 2005.
(60) Provisional application No. 60/710,030, filed on Aug. 18, 2005.
(60) Provisional application No. 60/598,641, filed on Aug. 4, 2004.
(60) Provisional application No. 60/620,571, filed on Oct. 20, 2004.
(60) Provisional application No. 60/573,219, filed on May 21, 2004.

(51) Int. Cl. H04L 29/08; G06F 16/22; G06Q 30/02

(52) U.S. Cl. CPC H04L 67/327; G06F 16/22; G06Q 30/02; H04L 67/325; H04L 67/02; H04L 67/306; H04L 67/20

(57) ABSTRACT

The invention provides a system and a method of providing time sensitive information on a multimedia device. The method includes receiving a multimedia file associated with feed formatted content at a multimedia device, receiving a time activator associated with the multimedia file and the feed formatted content at the multimedia device, storing the multimedia file in association with the time activator at the multimedia device, receiving an information request, determining a time factor, and selectively providing the multimedia file on the multimedia device based on the information request, the time factor, and the time activator.

The invention further provides a system and method of providing user interest to a potential feed publisher. The method includes providing at least one feed, providing at least one information request feed item in the feed, receiving request information associated with the feed; and providing the request information to a potential feed publisher.

### RELATED APPLICATION DATA

This application is a continuation of pending U.S. patent application Ser. No. 14/949,792 filed Nov. 23, 2015, which is a divisional application of Ser. No. 11/352,839 filed Feb. 13, 2006, which claims the benefit of U.S. Provisional Application Ser. No. 60/652,283 filed on Feb. 11, 2005, and Provisional Application 60/710,030, filed Aug. 18, 2005. U.S. patent application Ser. No. 14/949,792 filed Nov. 23, 2015, is also a continuation of Ser. No. 11/573,178, filed Feb. 2, 2007, which claims the benefit of PCT Serial No. PCT/US2005/027659 filed Aug. 4, 2005, and claims benefit of U.S. Provisional Applications Ser. No. 60/652,283 filed Feb. 11, 2005, 60/598,641 filed Aug. 4, 2004, 60/620,571 filed Oct. 20, 2004; and a continuation of Ser. No. 11/134,116 filed May 20, 2005, which claims priority from Provisional Application 60/573,219 filed May 21, 2004. The entirety of each application is hereby incorporated by reference.

### FIELD OF THE INVENTION

The present invention generally relates to feed formatted content. More specifically, the present invention relates to the creation, management, display, tracking, and monetization of feed formatted content and social networking.

### BACKGROUND OF THE INVENTION

The networked world, particularly the Internet and World Wide Web (WWW), has provided numerous communication formats. Two of the most ubiquitous include email and HTML web pages. Over the past several years, there has been an increased adoption and development of feed formatted content as a method of communication.

FIG. 1 shows representative feed formatted content 100. FIG. 1 is an example of XML, and specifically RSS, however it should be understood that other types of feed formatted content may contain like elements and be employed to accomplish like functions. Feed formatted content is structured data, such as for example Electronic Data Interchange (EDI), Extensible Markup Language (XML), or a subset of a general format such as RSS (Rich Site Summary or Really Simple Syndication), a hybrid or extension of some such standard, or the like. Feed formatted content 100 may be publicly or privately available and accessed through a feed, via a local or remote URL, stored in a local file, or the like. The term feed formatted content is a descriptor of both a whole and parts, in that it may describe an entire feed, a portion of a feed, a feed item, or a portion of a feed item. The term feed formatted content may also be used to describe content that was previously transferred in feed format. The term feed is location and the data returned when a request for feed formatted content is made.

Feed formatted content may include a feed header 101. In one embodiment, feed header 101 includes a header labeling feed formatted content 100 as XML data, and further provides two element wrappers: rss and channel. Fead header 101 may include a feed title 102 that names the feed, a feed link 103 that provides a Uniform Resource Identifier (URI) or Uniform Resource Locator (URL) to a resource that may be associated with the feed, a feed description 104 that may provide an explanation of the feed or feed contents. A feed header is not required in feed formatted content, and may contain less information than described, or may contain additional information such as standards used, format extensions, namespaces, or the like.

Feed formatted content 100 often represents multiple items, as is displayed in FIG. 1. Each feed item 106 may represent one or more news headlines, events, search results, items for sale or any other data. Feed item 106 may contain any number of elements. For example, it may include a title element 107, link element 108, and a description element 109. A feed item is not required in feed formatted content, and may contain less information than described, or may contain additional information such as content section wrapper 110, optional namespace elements 111 such as those in the xCal Document Type Definition (DTD), one or more enclosures 112 such as multimedia files, text documents, executable files, or the like. Terms have been adopted to describe feed formatted content with certain content. For example, a podcast is feed formatted content that includes an audio file as an enclosure 112, and a photoblog is a feed that includes images either in the description element 109 or as one or more enclosures 112.

Feed formatted content may be created for communicating between programs, computers or companies without the intention of display to an end user. Feed aggregation and display can be achieved in several ways. For example, aggregators may be stand alone desktop applications, plugins to existing applications such as Microsoft Outlook, or applications on a wireless device such as a cell phone or PDA. Desktop software solutions are commercially available, for example, under the names Pluck, and FeedDemon. Using such programs, feed requests are made directly from the desktop software from an end user's computer. A web-based approach, for example, is available at the website maintained under the commercial name Bloglines. This website maintains feed subscription information in a central user database and feed requests are made by a remote server and displayed on the Bloglines website.

One problem with current aggregator solutions is that it is often difficult or impossible to manage feed formatted content across various aggregator interfaces. For example, one might maintain a subscription list for wireless access of feed formatted content separately from a subscription list for a web-based aggregator. The problem becomes more significant if one considers maintaining records of what feed formatted content has been viewed, read or recommended across various delivery platforms. Many services peripheral to feed formatted content may also be useful to maintain over various delivery platforms, such as contact lists, calendars, and the like, but again solutions are either currently unavailable or inadequate.

Many aggregators show titles, similar to the news or information pages of any standard website. Often the information on aggregator sites or in aggregator programs, collectively aggregators, has been aggregated from multiple sources, however this is not required. An aggregator as a presentation method may still require a user to selectively view individual titles from a collection of titles. From the presentation standpoint, it may be unclear what the user did or did not read, let alone see. One of the purported uses of aggregators is that an aggregator allows a user to specify only the information they wish to receive, simplifying and filtering the information displayed to them. However, as the number of subscriptions increases or as more information is posted to subscribed feeds, the amount of information a user may be presented with may become overwhelming. A method of filtering or prioritizing subscribed information is therefore desirable.

Feed formatted content is generally designed for transfer over networks and between computers, but transfer of information between users is still not adequately addressed. For example, a user who has read a feed item that they found to be interesting or useful may wish to make that opinion known. Currently, a user might copy link element 108 and post it on another website, or might send it using an email program. It would be useful to make tracking responses, creating and processing recommendations, and generally transferring feed formatted content between individuals easier.

Directories and search engines of feed formatted content exist, published or maintained by various individuals and groups. However, awareness of what kinds of information and specific information sources are available as feed formatted content remains low. Additionally, an individual may not be able to identify the sorts of information they may be interested in receiving. Generally, finding and subscribing to feed formatted content continues to be a difficult and confusing task for many individuals. It would be useful to create a method that allows a user to find feed formatted content to which one may subscribe.

In recent years, several web-based social networks have arisen. A social network may be defined in a few ways. A social network is a list of relationships between one individual and other individuals. A social network may also refer to a recordation of such a list in a database. A social network may also refer to a system of recording the relationships between individuals. Web-based social networks are based on the creation of a user account within the social network and the recordation and display of relationships between the user accounts. One problem with current social networks is that they are isolated a particular social network service. For example, a user of Friendster, a commercially available social network at http://www.friendster.com/, may set up an account at MySpace, another commercially available social network at http://www.myspace.com/. The relationships recorded at Friendster are not available at MySpace. Another problem is that social networks are limited in use on their own. It would be useful to incorporate other services within a social network to increase their utility.

A variety of commercial and private entities as well as individuals provide feed formatted content, others provide aggregation, and others provide social networking. In many cases these service providers make very little or no income at all. It would be useful to provide a method of monetizing feed formatted content and social networks.

Conventional web pages do not separate the display interface, often HTML, from the data being displayed, which is often simply text and images embedded within the HTML. Updates to such standard web pages require a page request to a web server, reloading the data displayed on the page as well as all other interface elements. While this model works well for single information requests, it may not be the best model for information that is more dynamic and suggests frequent loading in a similar interface layout. It would be advantageous to have a method of solving the above inefficiencies in the consumption of feed formatted content and in social networks.

In summary, it would be useful to provide improved methods for social network and feed formatted content creation, management, display, tracking, and monetization.

### SUMMARY OF THE INVENTION

One aspect of the invention provides a method of providing user interest to a potential feed publisher. The method includes providing at least one feed, providing at least one information request feed item in the feed, receiving request information associated with the feed, and providing the request information to a potential feed publisher.

Another aspect of the invention includes a system of providing user interest to a potential feed publisher. The system includes means for providing at least one feed, means for providing at least one information request feed item in the feed, means for perceiving request information associated with the feed, means for storing a record of the request information; and means for providing the request information to a potential feed publisher.

Another aspect of the invention provides a method of providing time sensitive information on a multimedia device. The method includes receiving a multimedia file associated with feed formatted content at a multimedia device, receiving a time activator associated with the multimedia file and the feed formatted content at the multimedia device, storing the multimedia file in association with the time activator at the multimedia device, receiving an information request, determining a time factor; and selectively providing the multimedia file on the multimedia device based on the information request, the time factor, and the time activator.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates one embodiment of feed formatted content, as known in the art;

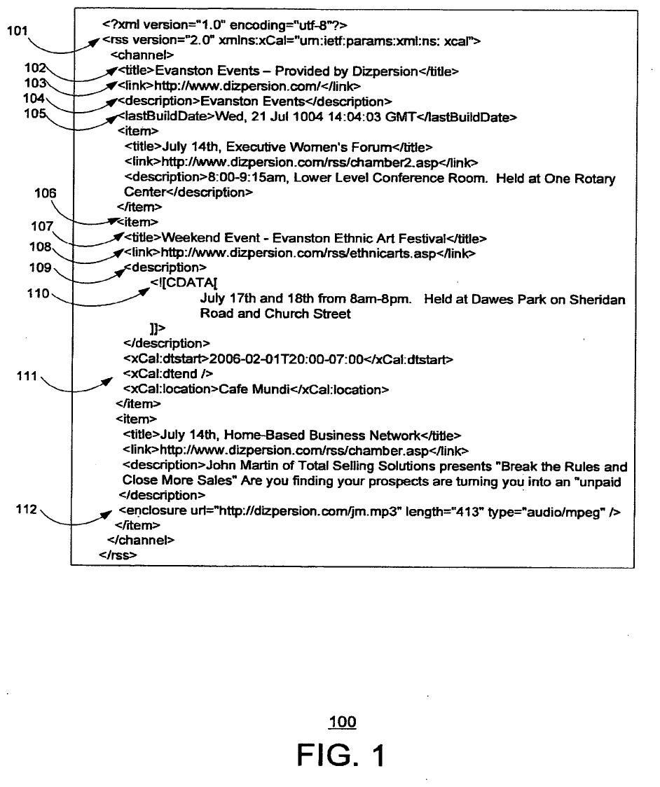

FIG. 2 illustrates a schematic diagram of one embodiment of a telecommunication system of the present invention;

FIG. 3 illustrates a flowchart representative of one embodiment of a method for tracking feed recommendations;

FIG. 4 illustrates a flowchart representative of one embodiment of a method for tracking feed recommendations;

FIG. 5 illustrates a flowchart representative of one embodiment of a method for operating a survey;

FIG. 6 illustrates a flowchart representative of one embodiment of a method for operating a prospective project review;

FIG. 7 illustrates a flowchart representative of one embodiment of a method for online communication;

FIG. 8 illustrates a flowchart representative of one embodiment of a method for online communication;

FIG. 9 illustrates a flowchart representative of one embodiment of a method for docketing;

FIG. 10 illustrates a flowchart representative of one embodiment of a method for docketing;

FIG. 11 illustrates a flowchart representative of one embodiment of a method for docketing;

FIG. 12 illustrates a flowchart representative of one embodiment of a method for docketing;

FIG. 13 illustrates a flowchart representative of one embodiment of a method for providing time sensitive information on a disconnected network device;

FIG. 14 illustrates a flowchart representative of one embodiment of a method for providing time sensitive information on a disconnected network device;

FIG. 15 illustrates a flowchart representative of one embodiment of a method for providing user interest to a potential feed publisher; and

FIG. 16 illustrates a flowchart representative of one embodiment of a method for providing user interest to a potential feed publisher.

### DETAILED DESCRIPTION OF A PRESENTLY PREFERRED EMBODIMENT

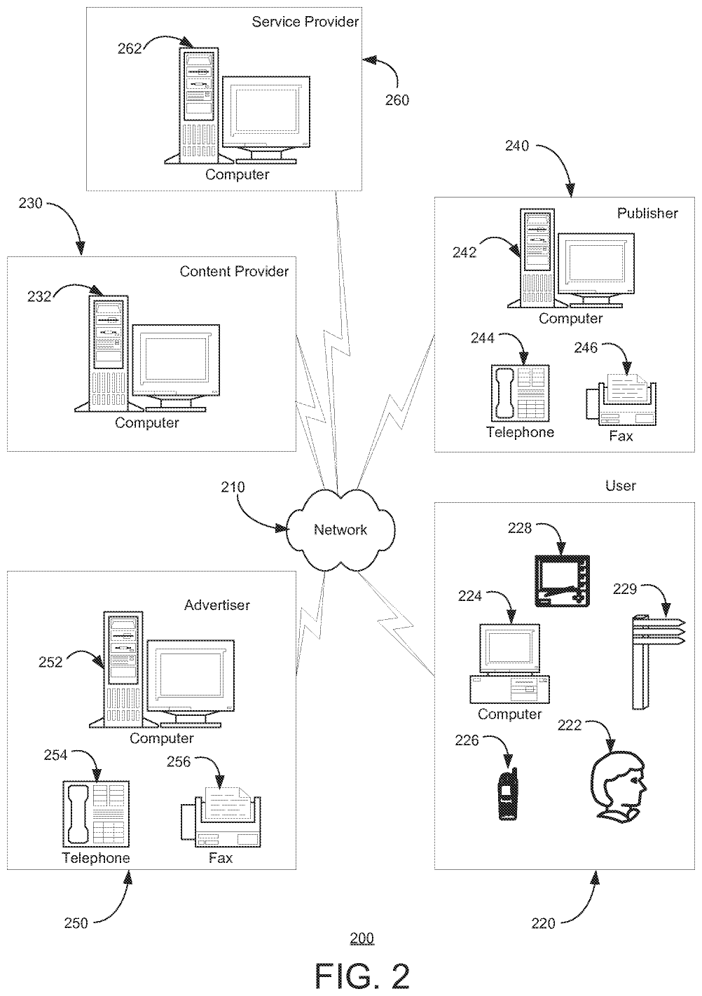

Referring to FIG. 2, a telecommunication system 200 of the present invention is shown. Telecommunication system 200 comprises a network 210 which provides the communications links between the various nodes of telecommunication system 200. Links through network 210 may include permanent connections (e.g., wire or fiber optic cables), temporary connections made through telephone, wireless or satellite communications, or various nodes of telecommunication system 200 may actually be hosted on the same physical hardware platform removing the necessity of a network link altogether. Network 210 may be in the form of public or private connections available over the Internet, an extranet, an intranet, a hard-wired local area network (LAN), a hard-wired wide area network (WAN), a wireless LAN, a wireless WAN, cellular network, satellite network, and/or other forms as would occur to those having ordinary skill in the art.

A user node 220 of telecommunication system 200 operates to facilitate communications information in audio form and/or visual form between a user 222 of user node 220 and one of the other nodes of telecommunication system 200. The information may be requested by user node 220 or may be pushed to user node 220 by another node. Devices, apparatuses and systems, such as for example, a cell phone 226, a personal digital assistant 228, and a personal computer 224 as illustrated, or any other user communication devices may be utilized within user node 220 to establish such communications. Devices, apparatuses and systems around the user may also be considered portions of user node 220, for example a digital signpost or digital billboard 229. Other suitable devices, apparatuses and systems not illustrated include networked household appliances (e.g., televisions, refrigerators, etc.), digital or satellite radio systems, and others as would occur to those having ordinary skill in the art.

A content provider node 230 includes one or more servers 232 for communicating with the other nodes of telecommunication system 200. The requested information, pushed information, and generally provided content can be in a variety of forms, such as, for example, a static or dynamic web page (HTML or XML), a radio or video broadcast or narrowcast, wireless application protocol (WAP) content, a short messaging service (SMS) message, or other forms of network information as known in the art. All content may be provided as the entirety of requested or provided content, or as a portion. For example, content provider node 230 may provide an entire web or WAP page or only a segment of a page. Accordingly, content server 232 can include suitable hardware platforms and software modules to operate as a web site server, a radio broadcast server, etc.

Referring again to FIG. 2, publishing node 240 includes one or more servers 242 for communicating with the other nodes of telecommunication system 200. Publishing node 240 may include apparatus and communications devices such as telephone 244, or fax machine 246. In one embodiment, publishing node 240 provides some portion or all of the content for content provider 230. Publishing node 240 may also publish content or advertisements for advertiser node 250. Publishing node 240 may include interfaces for uploading or inputting by some means content that is to be published via network 210.

Advertiser node 250 represents advertisers that may be any of an end advertiser of a product or service, a marketer, a publicist, a politician, any other similar party, or any party acting as an agent of the advertiser such as a media company, public relations company, advertising agency, or traditional publication. Advertiser node 250 may include apparatus and communications devices such as computer 252, telephone 254, or fax machine 256.

Service provider node 260 represents third party service providers, whose services may be incorporated into the present telecommunications system 200. For example, Mapquest or Google Maps may provide mapping functionality and services. Evite may provide event invitation and response management services. Quova may provide IP-to-geography translation services. Gracenote may supply its CDDB product and services. Friendster, MySpace, or the like may provide social network services. Paypal or Verisign may provide payment services. These service providers are only exemplary, and within each service category other service providers may be available, or another node of the system may provide like service. Service providers may also perform advertising or publishing functions. Service providers may operate as independent nodes of telecommunications system 200, or may provide copies of their code, databases, systems and the like for local installation on another node of telecommunications system 200. Service may be provided in the form of data feeds, application program interface (API), web services, or any other form of communication available in telecommunications system 200 as would occur to one skilled in the art.

While the nodes of FIG. 2 are illustrated and described as solely communicating using network 210, this is only to be considered a best mode, and not limiting. Various nodes, where possible, may communicate using other forms of communication including phone, fax, in-person meetings, mail, and other forms known in the art. In addition, each node may consist of more or fewer communications devices, personnel, and apparatus than are illustrated. Further, while the nodes, and further their component make-up (e.g. servers, databases), are described as operating independently and on separate platforms, it should be well understood by one skilled in the art that various functions of the node or functions of the multiple nodes may be performed on the same physical hardware, or spread in different configurations, arrangements and architectures among the various nodes.

User node 220, content provider node 230, publishing node 240, advertising node 250, and service provider node 260 may each provide or receive feed formatted content. Examples herein will typically focus on XML, and specifically RSS, but it should be understood that other feed formatted content may employ like solutions. The term marker shall typically refer to an element, attribute, or group of elements and attributes within feed formatted content, and the terms marker, element, and attribute shall generally be understood to mean formatted information within feed formatted content.

Feeds may be provided in a variety of ways. A feed may be provided from a Primary Content Provider (PCP), or feed source server, which is an original information source, such as, News.com or the New York Times. The feed from a PCP is accessed from a domain and URL maintained by the original source. Portions or all of the feed or feed content may be written or edited through outsourcing, outside software may be used to generate the feed, and interfaces hosted by another entity may be used in the feed generation. However, a PCP maintains all feed data locally. An Outsourced Content Provider (OCP) is a feed provider that provides feeds in an Application Service Provider (ASP) model. Feed data is managed and maintained remote from the original source, however the feed may still be hosted from a domain or URL maintained by the original source through remote data request. In one embodiment, an OCP may be employed by a PCP to manage the creation of feed formatted content, and the OCP may provide the ability, for example through FTP, to publish the feed formatted content at a server maintained by the PCP. An Aggregate Content Provider (ACP) may generate original feed content, but an ACP receives feed content and redistributes it in one or more feeds maintained by the ACP. Both an OCP and an ACP may be referred to as a feed intermediate server. Each node of telecommunication system 100 may act as, or use the services of, one or more PCPs, OCPs, or ACPs.

It should be noted that delivery of feed formatted content does not necessarily imply that an active push is involved. Delivery of feed formatted content may, in one embodiment, allow that the feed formatted content be made available for request. For example, the feed formatted content may be made available at some universal resource identifier (URI), or at some other location available to a user. Similarly, it should be noted that terms sending feed formatted content or providing feed formatted content do not necessarily imply that an active push is involved. Sending a feed formatted content may, in one embodiment, indicate that the feed formatted content is made available for request. For example, the feed formatted content may be made available at some universal resource identifier (URI), or at some other feed location available to a user. However, the delivery, provision, or sending method for the feed formatted content may not be through request of an XML feed, RSS feed, atom feed, or the like, but rather may involve a more active push of the content.

Feed formatted content may include certain enhancement markers, data and/or formatting to provide enhanced feed creation, management, delivery, organization, interaction, accountability, display, and the like. For example, enhanced feed formatted content may include elements additional to those shown in feed 100. Feed aggregation and display tools may ignore additional elements, and may be capable of aggregating and displaying feed items even if they do contain these additional elements. Inclusion of additional elements or markers within feed formatted content therefore may provide additional benefit if the aggregation and display tool is designed to process them, and may not disrupt standard feed formatted content aggregation and display.

In one embodiment, a link or button may be provided on the IAP or single item window to provide the user with peripheral information regarding an item. For example, peripheral information could include user or other third party commentary on the source or subject of the item, map information, similar items, general information, bonus or benefit information, or the like. For example, a feed item regarding college recruitment at a specific college could include a link to a college rating service. By way of another example, a restaurant special could include a link to rewards network miles per dollar information for the restaurant.

For example, a feed publisher may publish feed formatted content associated with a product or service available for purchase. In one embodiment, when a payment marker is present, an interface may display a “buy now” button or link that takes the user to a purchasing page on some other site. Alternatively, instead of directing the user to a site where they may purchase the product, the service receiving the feed formatted content may hold all necessary information regarding the purchase for the user. In one embodiment, the “buy now” button or link causes a form to be submitted to the merchant site including visible or hidden form elements and user info regarding the purchase and payment details. Alternatively, clicking the button may cause a web service to be called, or some other like communication with an order and/or payment processing service. In one embodiment, the “buy now” button or link may signal the service to process the purchase indicated in the feed formatted content. For example, a user may register for or create a feed that searches EBay® for a particular type of item at a certain price threshold. When that type of item becomes available on EBay for a set price under the threshold, a feed item representing that availability may be inserted into the user's feed and it may include a payment marker. In one embodiment, the payment marker may include the price, the user's EBay login information, the seller's information, an identifier for the particular item up for purchase, or other information relevant to the purchase. The “buy now” button or link displayed on the display interface may submit directly to the EBay site and process the transaction based on the login information and identifier. Alternatively, the “buy now” button or link may submit to a service provider. The service provider may hold a purchase script for EBay as well as other ecommerce sites. When the “buy now” submission is received at the service provider, the EBay purchase script may be executed. The script may include, for example, sending a post request to an EBay purchase page, sending a post request including user login credentials, and a post request confirming the purchase. In one embodiment, the service provider may communicate the purchase in some other manner such as, for example, electronic business XML (ebXML), a web services application program interface (API), or some other form of purchase data transfer. One-click purchasing can in many of the above-described embodiments be achieved separate from a central storefront.

By way of another example, a restaurant may publish feed formatted content, such as, for example, regarding a dinner special for a particular night. The restaurant may be enrolled in a rewards program such as the airline miles rewards program managed by Rewards Network Inc., formerly iDine. Users who are enrolled in this program would benefit from knowing that the restaurant is also enrolled, but that information may be superfluous for non-enrolled users. The restaurant feed formatted content may include a reward marker that either includes information about the particular reward deal at that restaurant, links to the reward deal, or simply indicates that the reward is available.

For example, the reward marker might indicate that twenty airline miles are earned per dollar spent at the restaurant. A feed formatted content display service may hold information regarding what users are registered with the rewards program, and may selectively display the reward availability based on the reward marker and the user information.

In one embodiment, feed formatted content may include one or more event date markers. While it is common practice to include a published date for feed formatted content, it would be advantageous to include a date marker particular to an event referred to in the feed formatted content. For example, feed formatted content provided by Ticketmaster® may include a feed item referring to a concert that will take place in two weeks. The published date reflects the first date the item is displayed in the feed, but the separate event date marker may be used to communicate the actual concert date. A user may specify a user preference that they wish to receive concert information as much as a month ahead of time. The server may provide them with the feed formatted content from Ticketmaster including the feed item referring to the concert. Alternatively, if the user only wishes to receive information about concerts coming up within the next week, the server does not provide the concert information. In one embodiment, a feed based calendar may be provided. A feed based calendar is a calendar that may associate information in a feed with presentation on the calendar, for example based on an event date marker, recurrence pattern, or the like.

In one embodiment, a server may provide an aggregate feed. The aggregate feed may be a feed made up, at least in part, of feeds for each individual advertiser. In one embodiment, the aggregate feed may be modified by the user to include a subset of the feeds or feed items in the aggregate feed.

In one embodiment, the feed formatted content publishing interface may include one or more options, for example as form elements, to specify one or more enhancement markers. For example, a payment marker, reward marker, event marker, or the like may be added to the content through the interface.

Feed formatted content may be singular in source or aggregated. For example, two restaurants may maintain feeds singular to their establishments. An aggregate channel of restaurant feeds may combine these two feeds to provide an aggregated restaurants feed. Any number of feeds or selected feed items from feeds may be combined to produce an aggregate feed. In one embodiment, a feed item incorporated within an aggregate feed may include an original source marker identifying its singular original source. When the feed formatted content from the aggregate feed is displayed at user node 220, a link to the singular original source or some means of subscribing or unsubscribing the user to or from the singular original feed, such as a button or link, may be provided. In this manner, if the user enjoys information from one singular original source in an aggregate feed, but wishes to unsubscribe from the aggregate feed, an easy method of subscribing to the singular original source has been provided. Alternatively, if the user wishes to maintain a subscription to the aggregate feed, but unsubscribe from one singular original source, an easy method of unsubscribing from the singular original source has been provided. In one embodiment, an aggregate feed is the feeds and feed items within a feed bucket.

In one embodiment, the feed formatted content publishing interface may include interface options for specifying recurrence of feed formatted content. A user may enter one or more recurrence patterns. The publishing node may publish the feed formatted content based on the recurrence pattern. The recurrence selection is associated with at least a portion of feed formatted content. A recurrence publication service may run on the server or against the information on the server. The associated feed formatted content is then selectively published based on the recurrence selection and the recurrence publication service. If the recurrence publication service determines that a new occurrence has occurred, the feed formatted content is published. If the recurrence publication service determines that a new occurrence has not occurred, no new content is published.

For example, the recurrence selection could be expressed via an interface. A user may select that a certain feed item should be published at 5 pm on each Monday. The server may, in one embodiment, store the recurrence selection as a recurrence pattern format such as the standardized iCalendar format. The recurrence publication service may run once a minute to determine if any new items are due for publishing. This may be achieved by selecting one ore more recurrence patterns, for example all recurrence patterns, or active recurrence patterns, or recurrence patterns associated with active feed formatted content or users, and the recurrence publication service then projecting the selected recurrence patterns over the time period since it last ran. If a new occurrence falls into that time period, the feed formatted content may then be published. In one embodiment, the publishing node may insert at least one globally unique identifier in the feed formatted content based on the recurrence selection. This globally unique identifier may indicate to feed aggregation programs that the feed formatted content is fresh, even though it is recurring in nature. In one embodiment, a recurring content identifier may be inserted with the published content. A feed aggregation program may be configured to allow a user to filter out feed formatted content containing a recurring content identifier associated with recurring feed formatted content. In one embodiment, a conditional publishing rule may also be associated with the feed formatted content. The feed formatted content may be published based on both the recurrence pattern and the conditional publishing rule.

In one embodiment, the feed formatted content may include a different globally unique identifier (GUID) for some portion of the feed formatted content based on the recurrence pattern. A different GUID may allow a feed aggregator to recognize recurring feed formatted content as unique. Alternatively, the published date of one or more portions of the feed formatted content may change based on the recurrence pattern, and may provide a uniqueness indication.

In one embodiment, the published feed formatted content may include a recurring content identifier (RCID). The RCID may indicate that at least a portion of feed formatted content is recurring in nature.

In one embodiment, publishing node 240 may receive calls from advertisers at a call center. If the advertiser has never worked with publishing node 240 before, account information may be entered into an advertiser database. In one embodiment, the account information may include information to be displayed on a landing web page for the advertiser or the advertiser may designate a URL for a landing web page. A feed may be established exclusively for the advertiser to hold the feed formatted content that is ordered. The feed formatted content ordered by the advertiser may be placed in a feed with other feed formatted content.

In one embodiment, a feed formatted content publishing interface may be provided, for example at a web site that allows users, advertisers, advertising agencies, or any other entity to log in to an account and create feed formatted content. For example, an advertiser may log into their account and encounter a page that includes a form requesting title, link, and description information that will be converted to feed formatted content and included in the advertiser's feed. Given the various methods by which feed formatted content may be created or published by publishing node 240, different pricing methods may be established to charge for the publication and management services. For example, publishing node 240 may charge a certain amount for a phone order but allow submissions via an online interface for a cheaper price or for free.

In one embodiment, the feed formatted content publishing interface may include the option to provide one or more conditional publishing rules. A user may enter one or more conditional publishing rules. The conditional publishing rules are associated with at least a portion of feed formatted content on the server or at an alternate location. The publishing node publishes the feed formatted content based on the conditional publishing rules. A conditional publishing rule may be a weather condition, a sporting event, a financial event, reservation availability, a product sale, or some other determinable condition. For example, a bar may have a beer garden open on weekend nights. A recurrence pattern may be associated with feed formatted content regarding the special. The recurrence pattern may indicate to publish the feed formatted content on Friday and Saturday of each week from May until November. The weather condition may be determined, in one embodiment, for example, by temperature or weather condition information in feed formatted content from a weather publishing service provider node. However, if one of those weekend days is not warm and/or has rain, the bar may wish that the feed formatted content not be published that day. A conditional publishing rule may be associated with the feed formatted content indicating that it should be published only if the weather is over a certain temperature. Another conditional publishing rule may be associated with the feed formatted content indicating that it should not be published if it is not raining. Weather information may be provided, for example, as feed formatted content by a service provider. The publishing node may receive the weather information and selectively publish the feed formatted content based on the weather information and the conditional publishing rules. Other examples of conditional publishing rules include rules based on portions of or outcomes of sporting events, stock prices, product sales, reservation availability, or the like. A service provider may provide such information, or it may be provided by the publishing node, or by the advertising node.

In one embodiment, the feed formatted content publishing interface may include tracking information. In one embodiment, the publishing node may collect the tracking information for display on the interface. Alternatively, the publishing node may employ a service provider for the tracking information such as, for example, that provided by FeedBurner™. A publishing node hosts a private version of feed formatted content. The publishing node may receive a request a public version of feed formatted content. The publishing node may request a second private version of feed formatted content based on the first private version of feed formatted content. The publishing node may publish the public version of feed formatted content based on the second private version of feed formatted content.

In one embodiment, the publishing node may register the first private version of feed formatted content with the tracking information service provider. The publishing node may post the URI of the private version of feed formatted content and provide it to the tracking information service provider. Other information may be included in the post such as publisher information, feed title, URI information, or feature selection information. The publishing node may store the tracking service identifier, for example URI of the second version of the feed formatted content as provided by the tracking information service provider. In one embodiment, the publishing node may cache the second version of the feed formatted content. The publishing node may, when it receives a request for the public version of feed formatted content, request the second version of the feed formatted content, and publish that feed formatted content to the requestor. Alternatively, the publishing node may provide the cached feed formatted content. The publishing node may request tracking information from the tracking information service provider and provide it, for example displaying it to a user via the feed formatted content publishing interface. In one embodiment, the publishing node may cache the tracking information. In one embodiment, the private version of the feed formatted content may include one or more recurrence selections, one or more conditional publishing rules, or a combination of selections and rules, and may be published based on these selections and rules.

In publishing feed formatted content, many uses may be achieved by tracking use and other response information with regards to the content or feed itself. Feed access, also called subscription, may be recorded anonymously or indexed to a particular user. For example, a request for a feed may not include personally identifying information regarding user node 220 that made the request. Alternatively, a request may be made from an identified user node 220. User characteristic information input is received into the system either through association with the anonymous request, the request itself indicating the characteristic of a user that has requested that feed or geographic location of the request established by IP address to geography translation, or through association with the user characteristic information associated with the identified user node. Characteristic information associated with the identified user node may include other feeds requested, feed access frequency, feedback received from the user with regards to one or more feeds or feed items, access frequency, age, sex, location, or other user information held in a profile or established by other means.

In one embodiment, profile information may be collected by the IAP either at registration or at some other time. This information may be used to provide profiled feed response tracking, and further to make feed and feed item recommendations to IAP users.

User profiles may be maintained by feed aggregation and display software at user node 220, at content provider node 230, at publishing node 240, or at advertiser node 250. The characteristic information received or input is then used to determine a characteristic profile of the requestor. Feed formatted content response data is then received and collected by the receiving node. Feed formatted content response data, collectively response data, may take many forms. In one embodiment, response data is related to feed formatted content interaction. For example, continued feed requests, discontinuance of feed request, or recorded removal of feed subscription may constitute response data. Further, response data may include clicking on links in a feed item, or other access of online resources referenced in the feed item. A cookie associated with the feed request may be employed to track indirect access of resources listed in or referenced in a feed item. For example, a feed item may reference a sale being held on a particular website and a link may be provided in the feed item to access that web site and a cookie associated with the request displaying that feed item may be placed at user node 220. If the user clicks on the included link, this action may be received as feed item response data. If the user later visits the web site, the cookie identifies them as having received the feed item and this action may be received as feed item response data.

Another method of receiving feed item response data includes the use of a user survey, and reception of associated user survey input. A feed item may include this user survey in its content. For example, a displayed feed item may have a link that says, “I liked this information.” If the user clicks on this link, it is received as feed item response data. There are many types of surveys that may be included, such as, providing the user the ability to rank the feed formatted content on a scale of one to ten, to provide a basic good or bad response, or to provide free form written response. The survey may be displayed with the feed item, or there may be a link to the survey in the feed item, or the resource available by following link element may include the survey.

Received feed formatted content response data is recorded in a characteristic profiled response database. This data may then be used for many purposes. For example, reports may be generated with individual or aggregated response information for feed publishers or other entities. For example, aggregate response information may be provided via an online interface to allow potential subscribers to view feed formatted content popularity or other feed formatted content characteristics. Collaborative filtering may be applied over the characteristic profiled response database to provide feed formatted content recommendations.

One embodiment of the present invention provides for sponsorship of feed formatted content. Sponsorships may be provided for entire feeds, for aggregate feeds, for individual feed items or subsets of a feed, or for groups of feed formatted content. Sponsorships may be provided in a variety of ways. For example, a feed item may include extra text in the description or title element indicating the sponsorship. Alternatively, when a link in a feed item is clicked, the user may be taken to an intermediate sponsorship page. An intermediate sponsorship page is a page that audibly or visibly indicates association with a sponsor. This intermediate sponsorship page may include a link to the actual desired content, or the page may refresh to display the desired content after a set period of time. In one embodiment, feed formatted content may include an audio or visual marker that is identified and played by the IAP when the feed formatted content is accessed. For example, when a feed formatted content is retrieved from News.com, an audio marker may be included for Intel. When the feed formatted content is provided, the audio marker may be identified and a linked audio file may be played that says, “This News.com feed is sponsored by Intel,” followed by the Intel jingle.

A geographic region identity is a set of parameters that define a geographic point or area. For example, a geographic region identity may be specified by providing a center point, be that a zip code, city, or precise longitude and latitude coordinates, and also providing a radius from that center point. When a zip code, city, or the like is provided as a point, the system may determine a latitude and longitude point within the provided area, for example at the centermost point. In one embodiment, the geographic region identity includes the entire zip code, city, or like area in the geographic region identity even if portions of it would be excluded by the determined center point and the provided radius. Alternatively, only the area determined by the center point and the provided radius are included in the geographic region identity. Providing multiple points that form a polygon may also specify a geographic region identity. Again the points may be zip code, city, or latitude and longitude coordinates, and the same inclusion and exclusion embodiments are included as described above. In one embodiment, a geographic region identity includes one or more zip code, city, state, country, or other region selections. In one embodiment, a geographic region identity may be determined by any combination of the above-described embodiments. For example, a center point and radius may be specified in addition to a list of cities to include. As another example, multiple center point and radius pairs may be specified. A geographic region identity may also include areas of exclusion. For example, a center point and radius may be specified that includes ten zip codes, but the user may specify that one of those zip codes is to be excluded.

In one embodiment, a geographic region identity may be determined based on double or single confirmation targeting. A geographic region identity may be determined based on a user profile on a site supplying the feed formatted content, or it may be determined from a profile on another site, such as Yahoo®. Alternatively, a geographic region identity may be determined by IP-to-geography translation. An IP-to-geography service, such as that provided by Digital Envoy, may be used to determine the location of the request.

The geographic origin of a request for sponsored feed formatted content may be determined in a variety of ways. The geographic region identity a sponsor has designated may be included in proposal information. Alternatively, a sponsor database holding sponsor information may include location information that may be associated with one or more sponsorship proposals. In one embodiment, the determination of feed formatted content sponsorship association 1710 and/or 1810 includes the geographic region identity. In one embodiment, the provision of a sponsored feed formatted content 1712 and/or 1812 includes the geographic region identity. Based on the geographic origin of a request for feed formatted content, a sponsor may be associated with the feed formatted content. Different sponsors may be associated with the same feed formatted content based upon requests for feed formatted content from different geographic origins. Different sponsors may also be associated with the same feed formatted content based on day part, profile demographics or any other method of online targeting known in the art.

In one embodiment, a sponsor may specify an author of feed formatted content in their sponsorship request or in their response to a sponsorship request. For example, a request for feed formatted content sponsorship may have multiple authors, and author markers may be included in the feed formatted content to identify each author. A sponsor may select to portions of the feed formatted content that is from one or more authors by including the author or author marker in their proposal information. An individual author of feed formatted content that is displayed in multiple feeds may also submit a request for sponsorship, and sponsorship associations may be made in association with that author.

In one embodiment, the user can read off the coupon numbers to the restaurant to get his discount. In one embodiment, the coupon will include a bar code, which can be read through the phone into a bar code scanner to receive a discount. In one embodiment, the bar code may be included in feed formatted content as a bar code marker. The bar code marker may include a link to a bar code image, or a code to generate a bar code. For example, a bar code marker may include numerical information that may be translated into a bar code. A program on the cell phone of the user may convert the received numerical information into a bar code display. This displayed bar code may be scanned, for example, at a standard checkout desk. Location information may be determined by GPS, signal triangulation, user profile information, any other method known in the art, or a combination of these methods, for example providing double confirmation targeting.

One embodiment of the present invention includes an Independent Access Portal (IAP). An IAP may include one or more of the functions of feed formatted content aggregation, management, and/or display. An IAP may incorporate, internally or externally, a variety of services such as, for example, social networking functions, messaging, wikis, bookmarking, or the like. An IAP may perform processes and methods such as feed aggregation, unique feed provision, as well as others included in this application. An IAP may include, produce, or use markers to allow enhanced feed provision, such as those that have been and will be described. In one embodiment, the IAP may be software at the user node 220, software at an OCP or ACP, or a combination of the two. The IAP may include one or more web based, cell phone, desktop application, or other user interfaces. For example an interface might be a standard web page, or combinations of web content and software. The term IAP may refer to any of these, and the term IAP server may be used to designate software or interfaces not held at user node 220, but one skilled in the art should understand that various aspects of the programming may be transferred between nodes and not depart from the spirit of the invention.

In one embodiment, trail markers can be attached to messages forwarded from one IAP user of the IAP network to other users. The trail marker may be embedded in the forwarded item. In one embodiment, a trail marker may be an identifier for recorded information in a database. Alternatively, a trail marker may be a data structure included with a message that holds recorded information. The trail marker provides functional history as selected by the sender or as selected by a command instruction. For example, in one embodiment, the trail marker contains instruction to determine all users that have received and viewed the item. The sender will have a history of who received the item at their IAP viewer.

A trail marker may include instructions regarding what message is to be displayed next. For example, a trail marker may contain the database identifier of the next message that is to be displayed. Alternatively, the trail marker may contain an additional message or message text that may be delivered next. The trail marker may indicate to add an item to the user's message queue. In one embodiment, the trail marker may include conditional logic regarding whether or which message should be displayed based on a user reaction to the displayed message holding the trail marker. Multiple trail markers may be included to provide alternative next messages or messages to be queued.

The trail marker may also record a reaction to the item and send one or more items based on the reaction. For example, a newspaper may send out a survey question as an item to the IAP users and based on a user response send out a follow up survey question. A survey feed including a trail marker attached to the lead survey item can skip to the appropriate feed item based on user reaction to allow for a more concise survey. In one embodiment, the trail marker can select a follow up survey question based in whole or in part on information from the user's profile. Political candidates, governments, businesses, etc., can get a more thorough understanding of their members or constituents.

In one embodiment, the trail marker attached to items may include instructions to allow only certain users to read it. These users may be the sender, the receiver or any other designated user or users.

Trail markers may be cut after a certain percentage of users respond, or certain amount of data is retrieved.

For example, in a project group, an idea or proposal item can be sent from one IAP user to users in the project group with a response trail marker attached. The trail marker instructions can include an approval threshold. The IAP users that receive the idea item can recommend or not recommend the item. If the threshold is met, the idea item can be sent with the trail marker to the project manager, who can read the trail marker to view the various reactions of the project members and take appropriate action. If the threshold is not met, the trail marker may contain a command to delete the idea item or file it in a premature idea file. Members receiving the idea item may create a new adjusted or alternative idea item, which will include a link to the original idea item. The adjusted idea item can also include a trail marker that compares approval between the original and adjusted idea item and forwards the item with the greater approval, or both if a certain threshold is reached. The trail marker may also include an instruction to locate a common open calendar date for group discussion on the approved item, and load a project discussion item in each group members feed calendar.

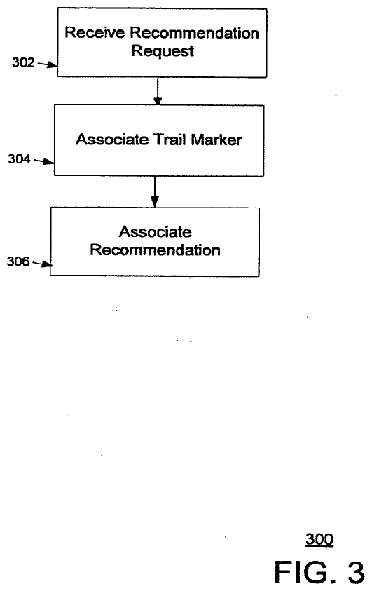

FIG. 3 illustrates a flowchart representative of one embodiment of a method for tracking feed recommendations at 300. A request is received to recommend a feed item to a user in a social network 302. A feed item trail marker is associated with the feed item 304. A recommendation is associated with the feed item trail marker 306.

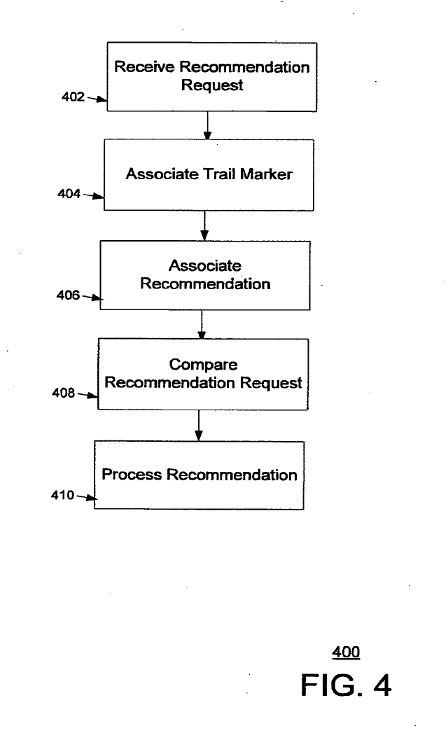

FIG. 4 illustrates a flowchart representative of one embodiment of a method for tracking feed recommendations at 400. A request is received to recommend a feed item to a user in a social network 402. A feed item trail marker is associated with the feed item 404. A recommendation is associated with the feed item trail marker 406. The recommendation request may be compared to other recommendation requests based on the feed item trail marker 408. The recommendation may be processed based on the comparison 410. Associating a recommendation with a feed item trail marker may, in one embodiment, include creating the feed item trail marker. The feed item trail marker may be indexed to the recommendation, or alternatively the recommendation or a representation of the recommendation may be inserted in the feed item trail marker.

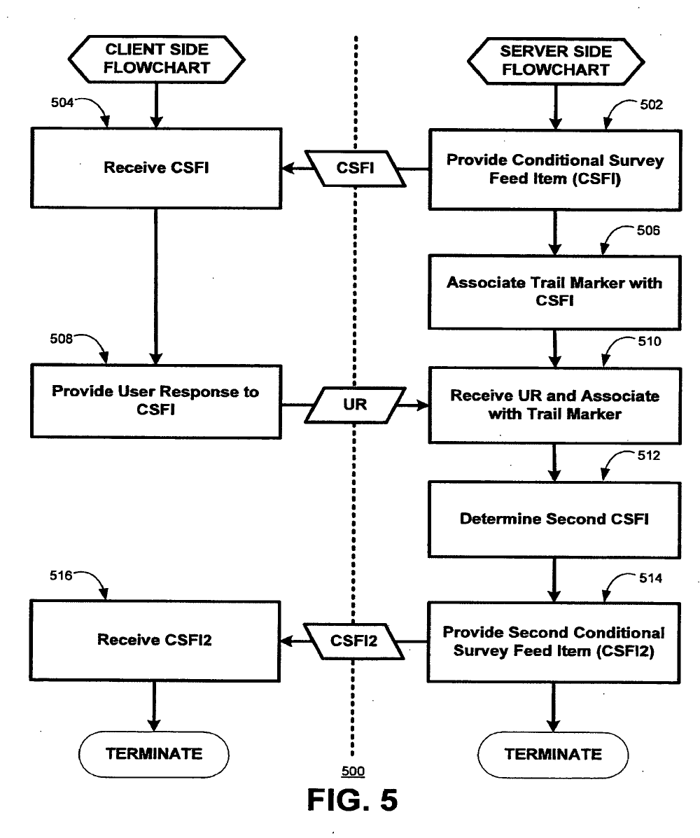

FIG. 5 illustrates a flowchart representative of one embodiment of a method for operating a survey at 500. The flowchart indicates a process run on a server, for example an IAP server at content provider node 230, and a process run client side, for example at user node 220. Some or all of each process may be performed on different nodes as would be apparent to one skilled in the art. A first feed item from conditional survey feed is provided 502. The first feed item is received 504. A feed item trail marker is associated with the first feed item 506. A user may then provide a response to the first feed item 508. The user response is received and associated with the feed item trail marker 510. Based on the user response, a second feed item is determined 512. The second feed item is the provided 514. The second feed item is then received 516. In one embodiment, one or more of the feed items may be delivered to multiple survey participants. A plurality of responses may be received from these participants, and the second feed item may be based on this plurality. For example, if more than half of the received responses to a first feed item include a certain response, a different feed item may be served than if it was less than half. Survey responses may be stored in the feed item trail marker and may optionally be displayed to a user participating in the survey.

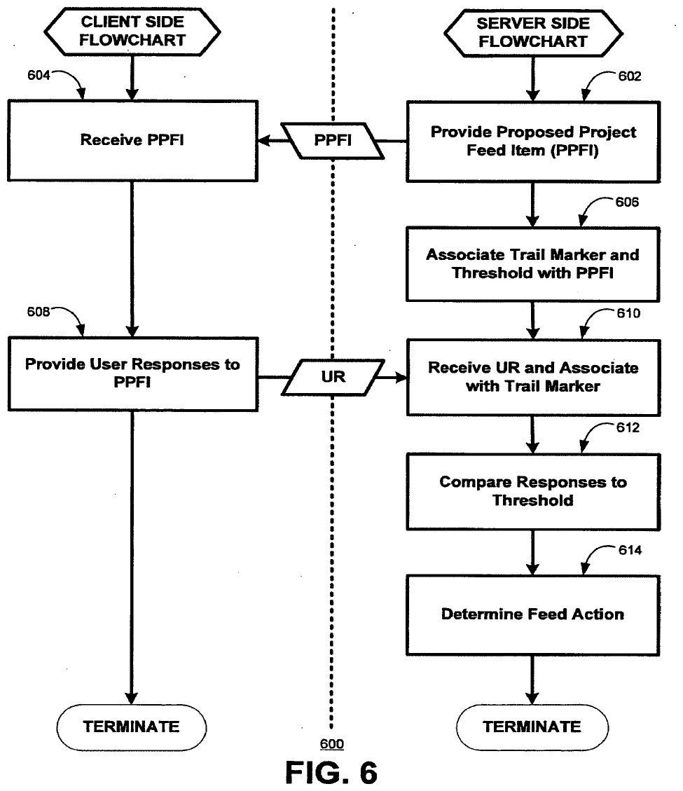

FIG. 6 illustrates a flowchart representative of one embodiment of a method for operating a prospective project review at 600. The flowchart indicates a process run on a server, for example an IAP server at content provider node 230, and a process run client side, for example at user node 220. Some or all of each process may be performed on different nodes as would be apparent to one skilled in the art. A proposed project feed item is provided 602. A user received the proposed project feed item 604. A feed item trail marker is associated with the proposed project feed item 606. In one embodiment, a threshold may be associated with the feed item or the feed item trail marker. One or more user responses are provided associated with the proposed project feed item 608. Each user response is received and associated with the feed item trail marker 610. The responses are compared to the threshold 612. A prospective project review feed action is determined based on the comparison 604. Such an action may include, for example, forwarding or recommending the feed item to a project manager. Alternatively, the action may include forwarding the results back to users who provided input, or marking the proposed project feed item as cancelled. In one embodiment, the proposed project feed item may only be provided to users within a project group. In one embodiment, only these users may respond to the feed item. Responses may be selectively recorded.

One embodiment of the present invention provides for private discussion threads. A private discussion thread provides a persistent train of a conversation. The thread may include a title, subject, or description that may be used to allow a user to search for or identify a particular thread. The thread is a collection of posts. A post may include a title or subject as well as a body of text. A post may include associated information such as on or more files, feed items, links, or the like. A private discussion thread may provide access only to certain individuals. For example, a user may create a private discussion thread and provide share information associated with the thread. Share information may be, for example, a selection of one or more users of a system that may access the thread. Users may be selected, for example, from a list of contacts in a social network. Alternatively, users may be specified by email address. When a user is provided access based on share information, they have permission to view the thread. Permission may include the ability to view the history of posts made to the thread, or alternatively, the user may only be able to see posts made after the share information that provided them access. In one embodiment, only the user who created a thread may grant access based on share information. Alternatively, a system administrator may maintain access to threads, and may maintain the ability to provide or edit share information. In one embodiment, the ability to provide or edit share information may also be provided to other users by the administrator or thread creator.

A private discussion thread may, in one embodiment, have new share information provided, which may be referred to as an edit share request. A share request or edit share request may include a selection to make a thread public. A thread marked as public may, for example, be accessible to all users and all users may have permission to post to the thread. In one embodiment, share information requests may include information regarding the rights provided to a user. For example, a user may be provided with only permission to view the thread. A user may be provided with only permission to post to a thread. A user may be provided with only permission to grant one or more permissions to other users.

In one embodiment, groups of users may be established. A group may be based on a social network, such as a group that is first-degree friends of a particular user. A single user may create a group. Users may optionally join a group. In one embodiment, a group owner or administer may choose to accept or reject users wishing to join the group. A share information request may specify a group and the permissions granted to that group.

In one embodiment, filters may be provided on private discussion threads. For example, a thread may include posts from many users. These users may be both those connected and unconnected to a user of a social network. A filter may be provided to display only posts made by those connected to the user of the social network.

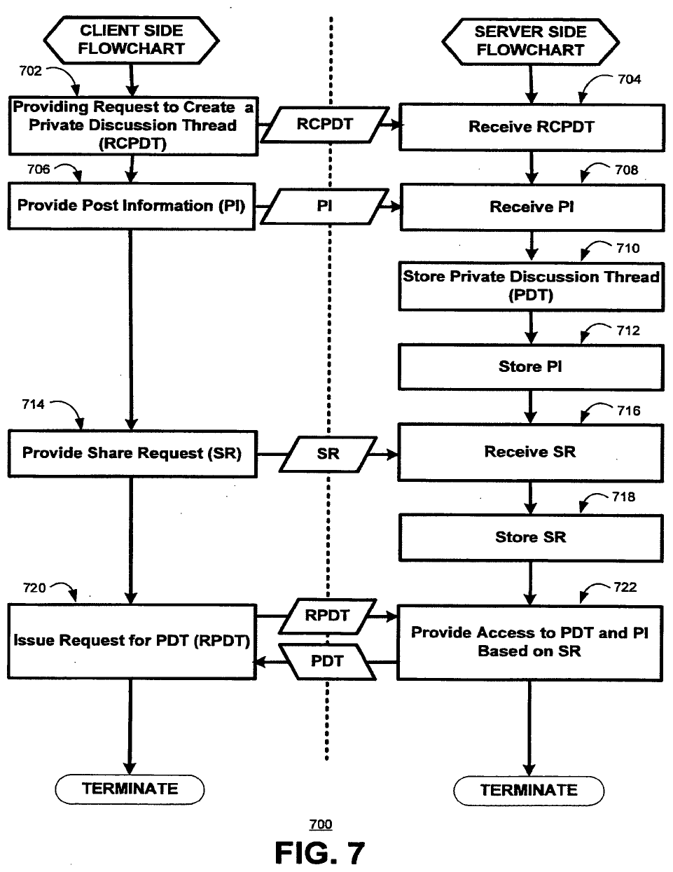

FIG. 7 illustrates a flowchart representative of one embodiment of a method for online communication at 700. The flowchart indicates a process run on a server, for example an IAP server at content provider node 230, and a process run client side, for example at user node 220. Some or all of each process may be performed on different nodes as would be apparent to one skilled in the art. A request is provided to create a private discussion thread 702. The request is received 704. Post information is provided 706, and received 708. The private discussion thread is stored 710, and the post information is stored in association with the private discussion thread 712. A share request is provided 714, received 716, and stored 718. A request for the private discussion thread is issued 720. Access to the private discussion thread and associated post information is provided based on the share request 722.

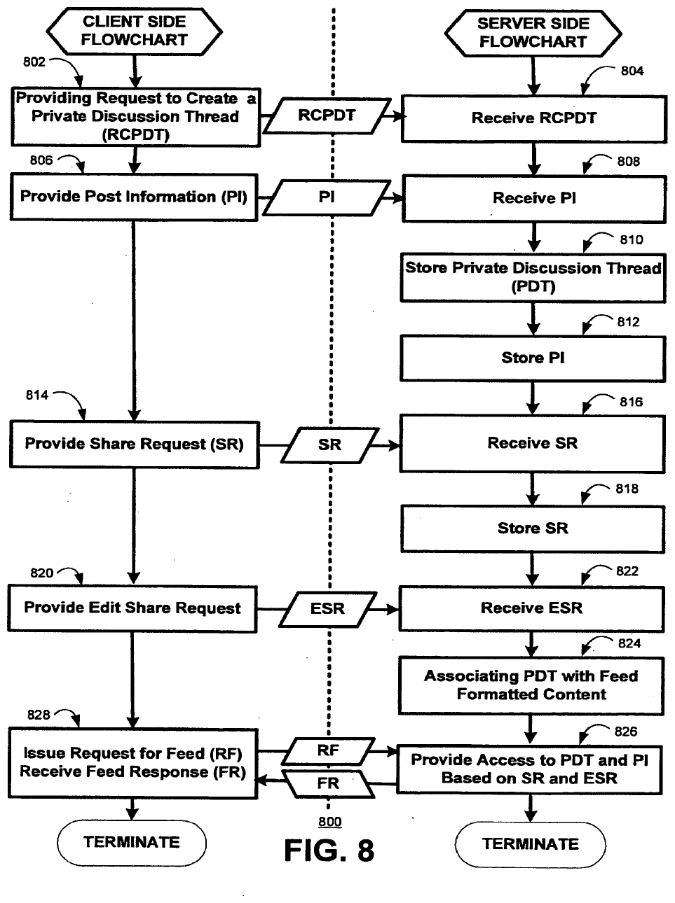

FIG. 8 illustrates a flowchart representative of one embodiment of a method for online communication at 800. The flowchart indicates a process run on a server, for example an IAP server at content provider node 230, and a process run client side, for example at user node 220. Some or all of each process may be performed on different nodes as would be apparent to one skilled in the art. A request is provided to create a private discussion thread 802. The request to create the private discussion thread is received 804. Post information is provided 806, and received 808. The private discussion thread is stored 810, and the post information is stored in association with the private discussion thread 812. A share request is provided 814, received 816, and stored 818. An edit share request is provided 820, and received 822. The private discussion thread may be associated with feed formatted content, for example a feed item 824.

In one embodiment, customized programs may be used to generate feed formatted content on an individual or group basis. Additionally, customized interfaces may be provided to interface with these feeds. For example, one or more programs may be developed to scan an online system such as the Patent Application Information Retrieval (PAIR) system provided by the United States Patent and Trademark Office (USPTO or PTO). Alternatively, no customized program may be required to generate the feed should it be made available by the USPTO.

By recording case numbers a user wishes to track, a program may scan the PAIR system to retrieve update information and place it in feed formatted content for retrieval by the user in feed format. In one embodiment, a docketing system may include a feature that uploads entered case numbers to a server. The server periodically scans the PAIR system based on the case numbers it has received. The docketing system also periodically checks the server for updated feed information regarding the cases. In one embodiment, the docketing system receives a filing input reflecting a filing of a paper with the PTO and, in the event that no update is recorded on PAIR within a predetermined span of time, such as 3 days, a notification is sent to a user of the docketing system. In one embodiment, the docketing system is configured to operate using the PACER system maintained by the United States District Courts, or by similar systems maintained by other judicial or administrative bodies. In one embodiment, feed information may be loaded into a feed based calendar, docket system, or status system, and may display the information or alert a user to received information or information not received within a certain period of time.

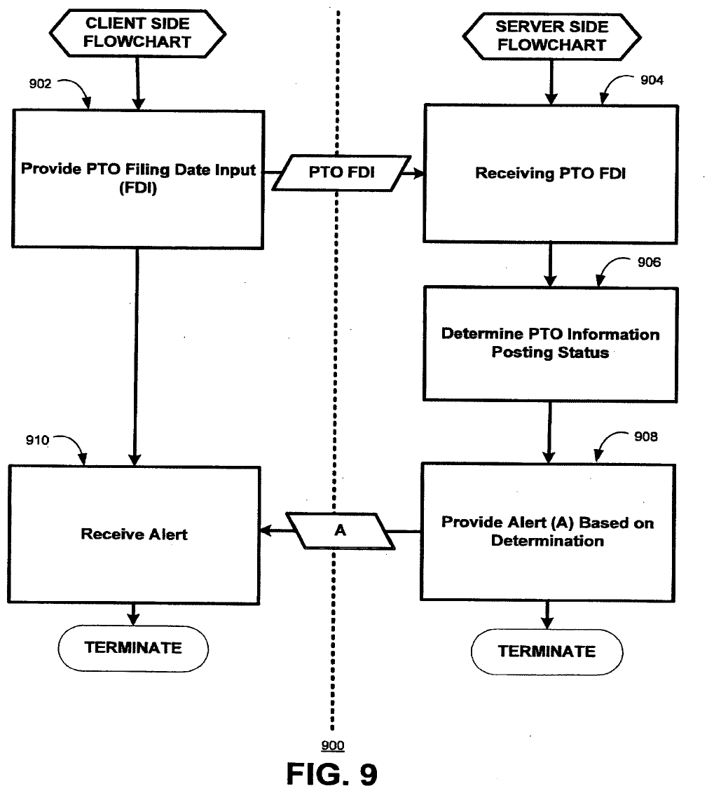

FIG. 9 illustrates a flowchart representative of one embodiment of a method for docketing at 900. The flowchart indicates a process run on a server, for example an IAP server at content provider node 230, and a process run client side, for example at user node 220. Some or all of each process may be performed on different nodes as would be apparent to one skilled in the art. PTO filing date input is provided at 902. The PTO filing date input is received at 904. A program may then scan the PAIR system periodically to determine whether information corresponding to the PTO filing date input has appeared on the PAIR system 906. Based on the determination, an alert notification is sent 908. The alert notification is received at 910. For example, an individual may prepare a continuation application. The individual may, upon mailing in this application, enter the filing date into a docket system. The docket system may then periodically check the continuity data section of the PAIR site associated with the parent application. When the continuation is posted on the PAIR site, an alert may be provided. If the continuation is not posted on the PAIR site after a certain period of time, an alert may be provided. An alert may be an email, a visual indicator on a docketing program, a text message to a cell phone, a feed item posted to a feed, or the like.

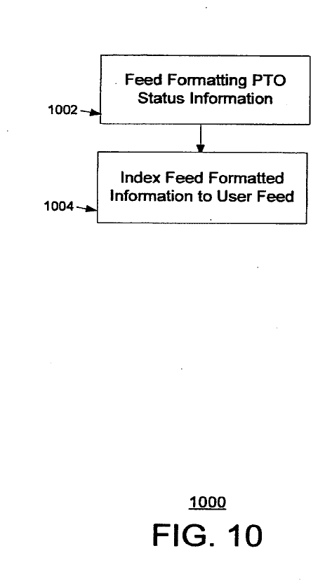

FIG. 10 illustrates a flowchart representative of one embodiment of a method for docketing at 1000. PTO status information from a PAIR website may be provided in feed format 1002, for example based on application identifier. The feed formatted PTO status information may then be indexed to at least one user feed 1004. For example, individual feeds may be provided for each tracked application. Aggregate feeds may also be maintained, for example an aggregate feed may include tracking information for multiple applications, such as a collection of those applications assigned to a particular attorney.

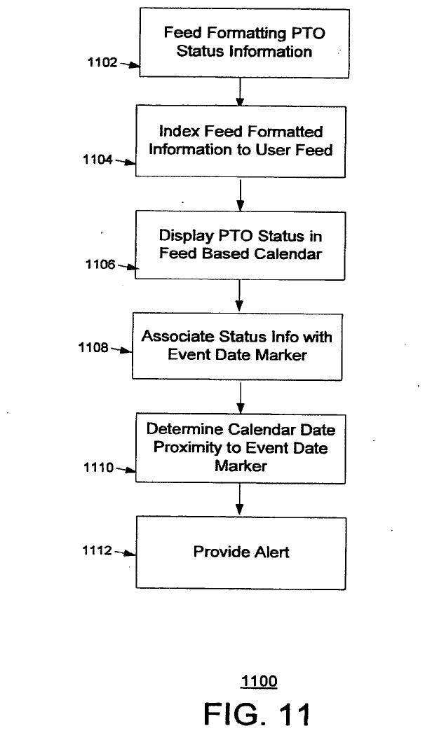

FIG. 11 illustrates a flowchart representative of one embodiment of a method for docketing at 1100. PTO status information from a PAIR website may be provided in feed format 1102, for example based on application identifier. The feed formatted PTO status information may then be indexed to at least one user feed 1104. Based on the user feed, PTO status information may be displayed in a feed based calendar 1106. The user feed may, in one embodiment, include at least one event date marker. The event date marker may be associated with the PTO status information 1108. The event date marker may be compared to a calendar date, and the proximity to that date determined 1110. An alert may be provided based on that determination 1112. An alert may be an email, a visual indicator on a docketing program, a visual indicator on a feed based calendar, a text message to a cell phone, a feed item posted to a feed, or the like.

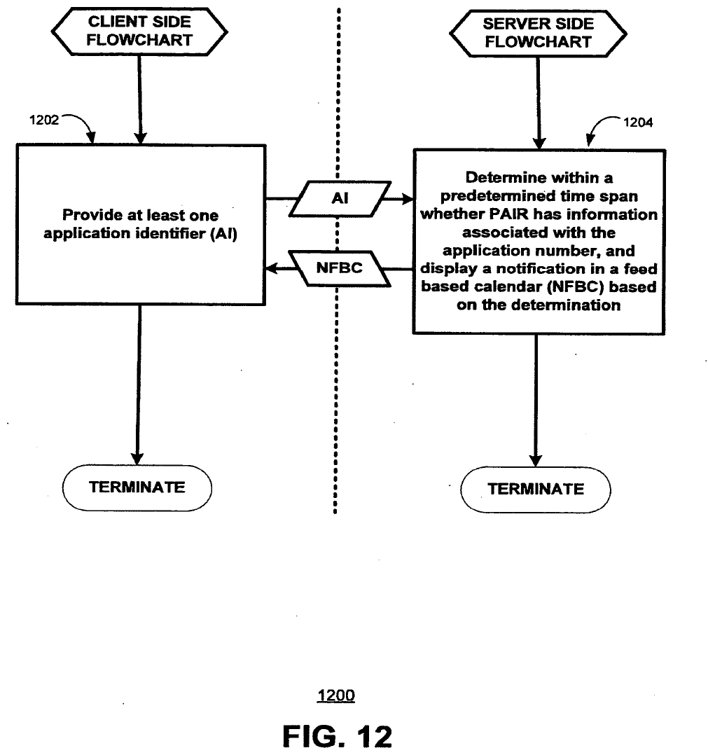

FIG. 12 illustrates a flowchart representative of one embodiment of a method for docketing at 1200. The flowchart indicates a process run on a server, for example an IAP server at content provider node 230, and a process run client side, for example at user node 220. Some or all of each process may be performed on different nodes as would be apparent to one skilled in the art. The client side provides at least one application identifier at 1202, and may optionally include a time span specification. The server side receives the application identifier, determines within a time span whether PAIR has information associated with the application identifier, provides feed formatted content of PAIR information, and displays a notification in a feed based calendar based on the determination at 1204. The application identifier, in one embodiment, may be a patent application number, a patent number, or the like.

In one embodiment, the IAP may facilitate certain podcasting functions and capabilities. Podcasting is the ability for a multimedia device to receive multimedia files associated with subscriptions to podcasts. A podcast is a feed that includes one or more multimedia markers. A multimedia device is a device capable of storing and playing multimedia files such as, for example, video and audio, and may include the ability to display text and image data as well. When the multimedia device is connected to the Internet it may pull down new content from the feed or from a program that has already collected information from the feed. In one embodiment, the IAP may maintain a list of podcast subscriptions for a user. In one embodiment, a podcast based on local feeds can be created. For example, a local food and entertainment feed can be provided as a podcast of audible feed items that may be read into an iPod or other multimedia device. Alternatively, a cell phone or other device may receive a podcast. In one embodiment, the feed item may be viewed as a text or graphic display in the multimedia device view window. In one embodiment, a coupon with barcode can appear in the multimedia device view window. A barcode marker may be associated with a podcast feed item. In one embodiment, the barcode marker may be included as part of the multimedia file. For example, the mp3 standard and associated tagging systems such as the various versions of 103 allow for an image file to be included within the file. Generally this image file is associated with an image representing an album cover, or the like, however this image may be, or include, a barcode. A user listening to a multimedia file may have the interface of the multimedia device display the barcode included in the multimedia file. In this manner a podcast may provide a barcode.

In one embodiment the IAP system can include an interface with or within a multimedia device dock interface that allows time sensitive feeds, including podcasts of food and entertainment feeds to be periodically downloaded into a docked multimedia device. The local feed podcast can be continuously or periodically updated with feed items as they are received via the provider interface. Alternatively, the local feed podcast can be provided through Apples' iTunes or other third party interface.

In one embodiment, a podcast can be constructed from feed items and also include time activators to allow feed items to be viewable and/or audible at particular times. For example, a podcast of entertainment and food feed items can be turned on near the day of the events or promotional offering. This will allow a user to download less frequently and not have to see information that is not time relevant.

In one embodiment, podcasting may include any combination of video, audio, and text, and may be consumed by any device or service capable of displaying any of these formats.

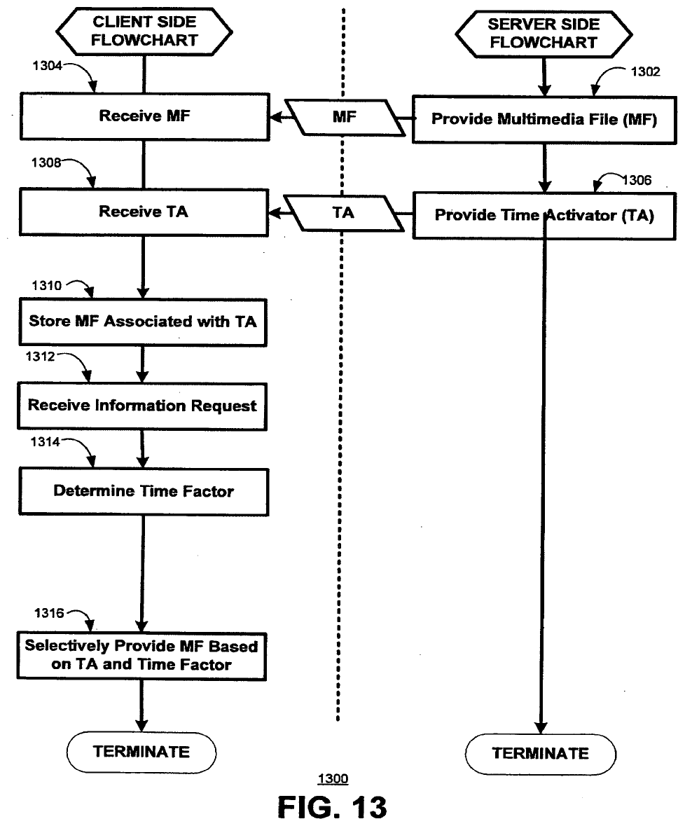

FIG. 13 illustrates a flowchart representative of one embodiment of a method for providing time sensitive information on a disconnected network device 1300. The flowchart indicates a process run on a server, for example an IAP server at content provider node 230, and a process run client side, for example at user node 220. Some or all of each process may be performed on different nodes as would be apparent to one skilled in the art. A multimedia file is provided 1302. A client receives the multimedia file at 1304. A time activator is provided 1306. The client receives the time activator 1308. The multimedia file and time activator are stored in association with each other 1310. An information request is received 1312, a time factor is determined 1314, and the multimedia file is selectively provided based on the time activator and the time factor 1316. For example, a user may be subscribed to a particular podcast that includes time sensitive information. When the user downloads the podcast, the feed formatted content may include one or more markers associated with a feed item. A feed item in a podcast will include a marker indicating the location of a multimedia file. A feed item may also include a marker indicating a recurrence pattern, a start date, an end date, some combination of these, or the like. The information in such a marker is a time activator. The time activator and multimedia file may be downloaded to a user computer and then transferred to a multimedia device, such as an iPod, or it may be downloaded directly to the device. The user interface of the multimedia device may include, for example, the option to view a list of songs in a podcast. When the user views this list, the multimedia device may determine a time factor, such as the current time, for example based on an internal clock, and compare the time factor to one or more time activators associated with the podcast multimedia files. The device may then display only the multimedia files determined to be active based on the comparison. Alternatively, a list of all the files may be provided, but a visual queue may also be provided indicating those active, not active, expired, or the like. In one embodiment, the device lists all files, but will only play those currently active. In one embodiment, the device may delete files that are expired. In one embodiment, selecting a podcast on the device may begin playback of associated multimedia files, without the step of displaying the files to the user. The device may selectively provide playback of the multimedia files based on the comparison of the time activator and time factor. In one embodiment, a time activator may be a time period. For example, the time activator may indicate that a multimedia file should be active for only a certain period of time, such as three days. The device may, in this case, not be required to maintain a current date but only a running timer to provide a time factor.

In one embodiment, a feed or the multimedia files associated with a feed may be provided based on a characteristic profile, such as that maintained in a characteristic profiled response database. In this manner, multimedia files such as local deals may be provided based on an individual profile.

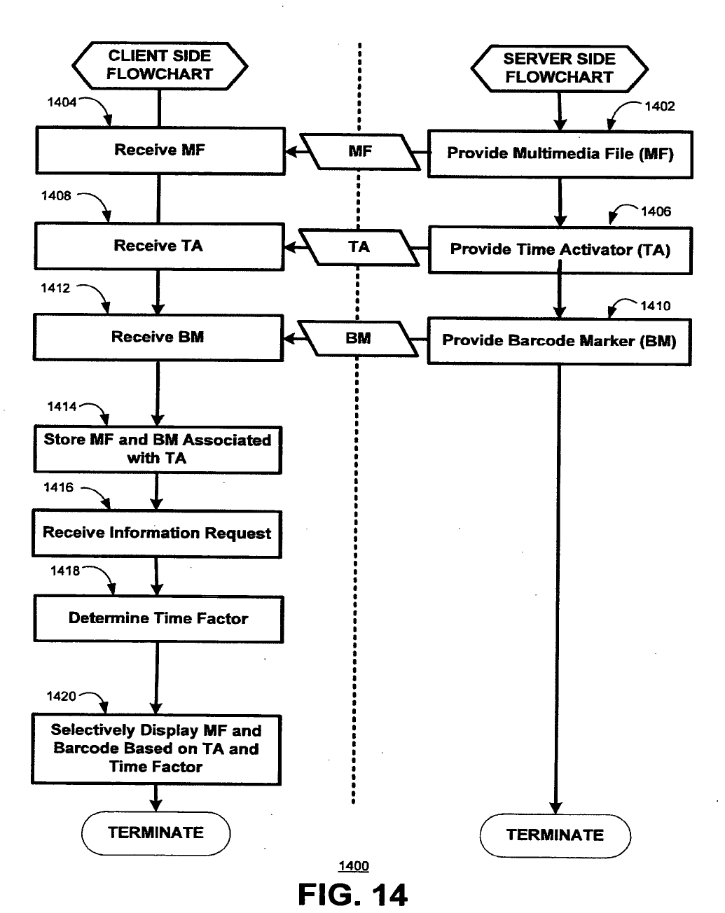

FIG. 14 illustrates a flowchart representative of one embodiment of a method for providing time sensitive information on a disconnected network device at 1400. The flowchart indicates a process run on a server, for example an IAP server at content provider node 230, and a process run client side, for example at user node 220. Some or all of each process may be performed on different nodes as would be apparent to one skilled in the art. A multimedia file is provided 1402. A client receives the multimedia file 1404. A time activator is provided 1406. The client receives the time activator 1408. A barcode marker is provided at 1410. The client receives the barcode marker at 1412. The multimedia file and barcode marker are stored in association with the time activator at 1414. An information request is received 1416, and a time factor is determined 1418. The multimedia file and barcode marker, or barcode generated based on the barcode marker, is selectively provided based on the time activator and the time factor 1420. In this manner, a device may provide a user with multimedia and barcode representations of a time sensitive coupon.

For example, an IAP may provide a podcast of local deals, some of which may be weekly recurring specials. A user of the IAP may have a profile that includes a geographic region identity. A user may also have interacted with feeds for various different local establishments, providing response data. Based on the geographic region identity, and optionally based on the response data, the local deals feed may provide multimedia files including time activators. The user may subscribe to the podcast in a program such as iTunes. Currently the iTunes program only downloads the multimedia files associated with a podcast. The program may be adapted to download other information in the podcast feed such as time activators, which may be, for example, event date markers. The program may save the entire feed, or a record of the event date information and associated multimedia file. If the entire feed is downloaded, the path information to the multimedia file in the podcast may be updated to reflect the locally stored copy. The user may then connect their iPod to their computer and synchronize their files. The synchronization may include downloading the new multimedia files from the deals podcast, along with the time activators. Again, the time activators may be transferred by themselves, or they may be transferred as an entire feed. The location of the multimedia file in the path information of a feed may again require updating. When the user elects to listen to the podcast on their iPod, they may do so either through the standard music selection interface, or through a custom interface, such as through a program stored under “extras” on the primary iPod interface. In either case, selecting the podcast may prompt the iPod to check its internally stored date, as is currently available in the “calendar” function. This date may then be compared to the time activators in the podcast, and only those files determined to be active based on the comparison may be displayed or played. Therefore, the user may listen to the podcast on a Monday and only hear about a weekly Monday wing special at a certain restaurant. Without synchronizing again, the user may listen to the same podcast the following day and only hear about a one night only performance by a band for that Tuesday night.

Functions may be provided via the IAP for users to manage one or more podcasts from their personal account, and allow businesses to run one or more podcasts as well. By way of another example, a user may run a feed that is only accessible to users in their friends' network. Users in that friend's network may request updates from their friend when they haven't heard anything from them in a while, or may post a specific question. Such update requests may be made anonymously or include user identification.

In one embodiment, a button, link, or other message system may be provided for signaling to a user or company that an update request has been made for a feed. For example, a user may request that a business post new information to its feed. The button, link, or other message system may be provided with the feed by the feed provider. Alternatively, a third party service provider may provide the information request mechanism. For example, a tracking service such as that provided by FeedBurner™ may include the information request mechanism. In one embodiment, a feed item may be provided to facilitate the information request process. This is an information request feed item.

In one embodiment, a publisher need not even host a feed for an information request to be collected. For example, a feed directory or search engine may return a placeholder feed for a potential feed publisher. A placeholder feed is a feed that is maintained and updated by a party other than that represented in the feed title or other feed information. A potential feed publisher is a company, person, service, organization or other entity that does not publish a feed, does not publish a publicly accessible feed, or has not provided a feed location to a service maintaining a potential feed publisher list.

For example, an art gallery may not have a feed, but a directory may list a placeholder feed of events hosted by that art gallery. The placeholder feed may include a feed item with a message such as, “click this link to let the gallery know you would like to see their events in this feed.” Request information associated with the placeholder feed may be collected. Request information may include viewing a feed or feed item on a web page, issuing an HTTP request for a feed, subscribing to a feed, viewing a feed or feed item in an aggregator, interacting with a feed item, such as, for example, clicking on a button, link or the like associated with a feed, receiving an email associated with a feed, or the like. Request information may be aggregated and provided to the party associated with the placeholder feed. For example, an email may be sent to the art gallery indicating that eight people are currently subscribed to the placeholder feed. Alternatively, information may be provided by fax, phone, via a web page, feed formatted content, text message, or any other means of notification known in the art. Information that people are awaiting posts at a placeholder feed may encourage a potential feed publisher such as the gallery to begin publishing their information in feed format.

A feed need not be a placeholder feed in order to provide the request information capability. For example, a publisher may not post to a feed for a period of time. The feed publishing system, or a third party system, may upon a certain elapsed time period include the request information option, for example in the form of an information request feed item. The information request feed item may, for example, be one that has a title such as “Miss hearing from us?” and a description that includes instructions to click a link or button to indicate the desire to receive new information posts. In one embodiment, the information request system may require a user account. In one embodiment, the information request system tracks request information from individual users, user nodes, or the like, in order to track or filter any system use or abuse.

In one embodiment, a placeholder feed may be replaced by a standard feed. The entity providing the placeholder feed may include a feed publishing solution. A potential feed publisher may use this publishing solution to begin managing their feed. In this way the end users subscribed to the feed will receive the information. Alternatively, the art gallery in the above example may use a publishing system not provided by the provider of the placeholder feed. The gallery may provide the URL of their feed to the provider of the placeholder feed. This publisher feed location information may be stored by the provider of the placeholder feed. Future requests to the placeholder feed may use an HTTP redirect, such as a HTTP 330 status code response indicating the publisher feed location information. Alternatively, the placeholder feed may provide a proxy to the provided publisher feed location information. In one embodiment, a portion or the entirety of the feed associated with the publisher feed location information may be cached by the provider of the placeholder feed.

In one embodiment, the request information may be stored. The request information may be sent in its entirety, as a summary, or in aggregate based upon reaching a certain elapsed time period, based on a request information threshold, or a combination of these. For example, an email might be provided to the potential feed publisher once a week. Alternatively, the email may be sent after a predetermined number of people, for example ten people, have subscribed to the placeholder feed.

In one embodiment, the request information, a summary of the request information, a request information threshold, or aggregate information associated with the request information may be provided to a user. For example, the information request feed item may indicate that eight people are currently subscribed to the placeholder feed and that the publisher will be contacted when that number reaches ten, the request information threshold. A user may provide a feed update assist request. A feed update assist request is a notification to another user of the existence or status of a feed, for example including the information request feed item. For example, a user may forward the information request feed item via the IAP to an associate. The associate may be one with a connection within a social network. Alternatively, a feed update assist request may be sent via email, instant messenger, or the like.

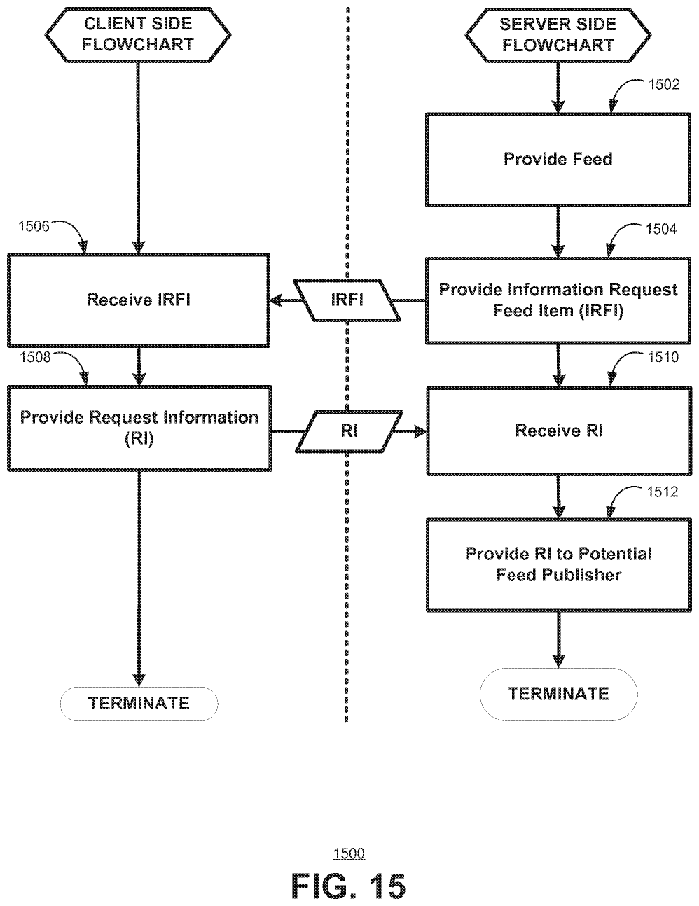

FIG. 15 illustrates a flowchart representative of one embodiment of a method for providing user interest to a potential feed publisher at 1500. The flowchart indicates a process run on a server, for example an IAP server at content provider node 230, and a process run client side, for example at user node 220. Some or all of each process may be performed on different nodes as would be apparent to one skilled in the art. A feed is provided 1502. An information request feed item is provided 1504. The information request feed item is received 1506. A request information is provided 1508. The request information is received 1510. The request information is provided to a potential feed publisher 1512.

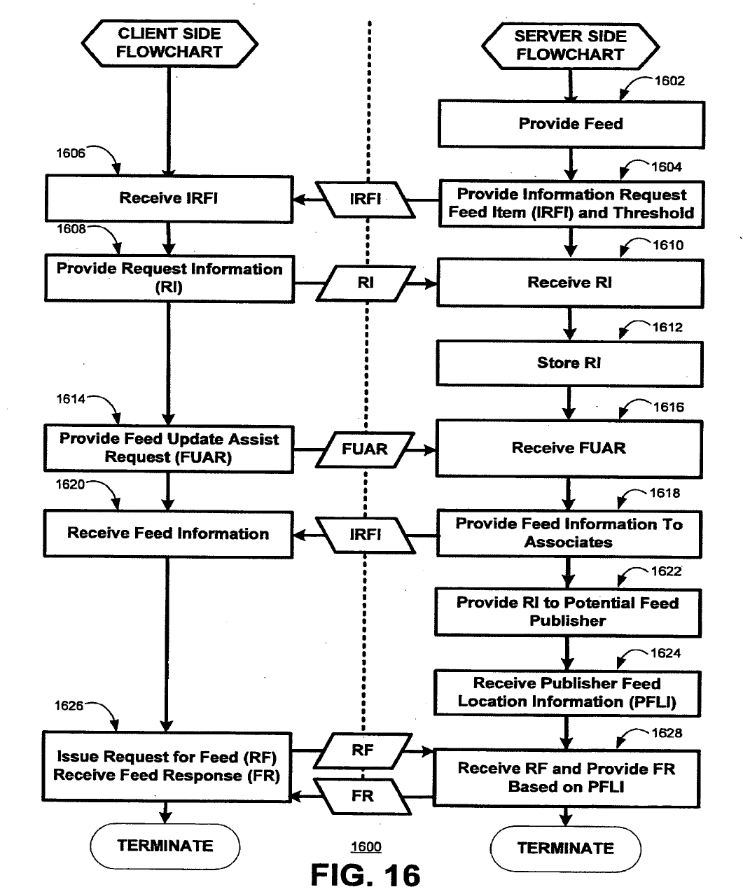

FIG. 16 illustrates a flowchart representative of one embodiment of a method for providing user interest to a potential feed publisher at 1600. The flowchart indicates a process run on a server, for example an IAP server at content provider node 230, and a process run client side, for example at user node 220. Some or all of each process may be performed on different nodes as would be apparent to one skilled in the art. A feed is provided 1602. An information request feed item is provided 1604. The information request feed item is received 1606. A request information is provided 1608. The request information is received 1610. The request information is stored 1612. A feed update assist request is provided 1614. The feed update assist request is received 1616. Feed information is provided to one or more associates 1618. Feed information is received by the one or more associates 1620. The request information is provided to a potential feed publisher 1622. Publisher feed location information is received at 1624. A request for feed is issued and feed response received at 1626. The request for feed is received and feed response returned based on the publisher feed location information 1628.

Combinations of the above described methods and systems may also be contemplated by one skilled in the art, and as such are in the spirit of the invention. The present invention may be embodied in other specific forms without departing from its spirit or essential characteristics. The described embodiments are to be considered in all respects only as illustrative and not restrictive.

We claim:

1. A method of providing time sensitive information on a multimedia device, the method comprising:
Receiving a multimedia file associated with feed formatted content at a multimedia device;
Receiving a time activator associated with the multimedia file and the feed formatted content at the multimedia device;
Storing the multimedia file in association with the time activator at the multimedia device;
Receiving an information request;
Determining a time factor; and
Selectively providing the multimedia file on the multimedia device based on the information request, the time factor, and the time activator.

2. The method of claim 1, wherein the multimedia device is a portable music player.

3. The method of claim 1, wherein the multimedia device is a cell phone.

4. The method of claim 1, wherein the multimedia file is associated with a characteristic profile.

5. The method of claim 1, further comprising:
Receiving a bar code marker associated with the multimedia file; and
Selectively displaying a bar code based on the information request, the time factor, and the time activator, and the bar code marker.

6. The method of claim 5 wherein the bar code comprises a bar code image imbedded in the multimedia file.
